(19) United States
(12) Patent Application Publication
(10) Pub. No.: US 2024/0020726 A1
(43) Pub. Date: Jan. 18, 2024

(54) SYSTEMS AND METHODS FOR INTEGRATING ADVERTISING WITH ATTRIBUTED OFFLINE SALES AND ANALYTICS PLATFORMS

(71) Applicants: Andrew Palosi, Thousand Oaks, CA (US); Vijay Singh, Reseda, CA (US); Brianna Skiffington, Winter Garden, FL (US)

(72) Inventors: Andrew Palosi, Thousand Oaks, CA (US); Vijay Singh, Reseda, CA (US); Brianna Skiffington, Winter Garden, FL (US)

(21) Appl. No.: 17/865,115

(22) Filed: Jul. 14, 2022

(51) Int. Cl. G06Q 30/02

(52) U.S. Cl. CPC G06Q 30/0246; G06Q 30/0277

(57) ABSTRACT

A system for integrating advertising with third-party platforms is disclosed, including at least one user computing device in operable connection with a network. An application server is in operable communication with the user network to host an application program for providing a system for integrating advertising with one or more third-party platforms. The application program having a user interface module for providing access to the application program through the user computing device. An ID generation module generates a unique click IDs for an online advertisement and a capture module to capture an IP address and unique calls.

### CROSS-REFERENCE TO RELATED APPLICATIONS

The present application claims priority to U.S. Provisional Patent Application No. 63/066,776 filed Aug. 17, 2020, entitled “SYSTEMS AND METHODS FOR INTEGRATING ADVERTISING WITH ATTRIBUTED OFFLINE SALES AND ANALYTICS PLATFORMS,” which is hereby incorporated by reference in its entirety.

### TECHNICAL FIELD

The embodiments generally relate to computerized systems and methods for integrating advertising with various platforms.

### BACKGROUND

Many businesses seek to monitor leads by tracking customer interactions. This includes managing and initiating initial contact with the prospective consumer/client all the way through negotiations, onboarding, and eventual execution of a deal. Client Relationship Management (CRM) systems have been developed to manage these processes. Some systems are segmented, in that data is not available in a single source, causing confusion for all parties involved. This problem is exacerbated when offline platforms are integrated into the process.

### SUMMARY OF THE INVENTION

This summary is provided to introduce a variety of concepts in a simplified form that is disclosed further in the detailed description of the embodiments. This summary is not intended to identify key or essential inventive concepts of the claimed subject matter, nor is it intended for determining the scope of the claimed subject matter.

The embodiments provided herein relate to a system for integrating advertising with third-party platforms is disclosed, including at least one user computing device in operable connection with a network. An application server is in operable communication with the user network to host an application program for providing a system for integrating advertising with one or more third-party platforms. The application program having a user interface module for providing access to the application program through the user computing device. An ID generation module generates a unique click IDs for an online advertisement and a capture module to capture an IP address and unique calls.

The systems and methods provided allow for the integration of click-generated ID's and IP data between one or more enterprise applications with advertising and analytics applications. The system further includes a method of tracking a customer from their original click, or multiple clicks throughout their conversion path, associating that click sourcing with their record that exists in either a CRM or our database, and reporting it back to the click originations for revenue and profit tracking in the advertising platforms by which they originated or contributed to the conversion path.

In one aspect, the record is associated with a CRM which may store a lead record.

In one aspect, record is associated with a conversion log database.

In one aspect, the system includes a client tracking module configured to track one or more customer interactions.

In one aspect, a conversion log module is configured to track one or more conversion paths and associate a clock with the lead record.

In one aspect, a third-party is in communication, via the communication module, with the application program. The third-party may be an offline third party.

In one aspect, a conversion log database stores one or more conversion logs to track a conversion path.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a block diagram of a computing system, according to some embodiments;

FIG. 2 illustrates a block diagram of a computing system and an application program, according to some embodiments;

FIG. 3 illustrates a block diagram of the application program and databases, according to some embodiments; and

FIG. 4 illustrates a block diagram of the system flow, according to some embodiments.

### DETAILED DESCRIPTION

The specific details of the single embodiment or variety of embodiments described herein are to the described system and methods of use. Any specific details of the embodiments are used for demonstration purposes only, and no unnecessary limitations or inferences are to be understood thereon.

Before describing in detail exemplary embodiments, it is noted that the embodiments reside primarily in combinations of components and procedures related to the system. Accordingly, the system components have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein.

In this disclosure, the various embodiments may be a system, method, and/or computer program product at any possible technical detail level of integration. A computer program product can include, among other things, a computer-readable storage medium having computer-readable program instructions thereon for causing a processor to carry out aspects of the present disclosure.

In general, the embodiments described herein relate to systems and methods for integrating click-generated ID's and IP data between one or more enterprise applications with advertising and analytics applications.

Some embodiments are directed to a method of tracking a customer from their original click, or multiple clicks throughout their conversion path, associating that click sourcing with their record that exists in either a CRM or our database, and reporting it back to the click originations for revenue and profit tracking in the advertising platforms by which they originated or contributed to the conversion path.

In some embodiments, for example, if a person searches Google for “AC Repair,” and clicks an ad that was created for a client's AC Repair company, and then “converts” by way of a phone call or a form fill, the invention may enable the ability to track a unique identifier. In some embodiments, the system may then associate the click with the record of that customer, and track the revenue and profit associated with their job and match it back to Google via offline conversion tracking. In some embodiments, the system may then enable the end user to utilize Google Ads to see the value of, for example, the ad, keyword, audience, device, zip code, day, hour, and various other data points that generated their job. In some embodiments the system may enable the user, over time and with enough data, to make optimization decisions toward conversion value rather than conversion cost.

In some embodiments, the system and method solves the problem of data being partially available in a segmented fashion but not being natively connected or trackable all the way through the digital conversion path. In some embodiments, this same concept may apply to any advertising platform that generates unique click generated IDs, such as, for example, Google Ad's GCLID, Facebook Ad's FBCLID and Microsoft Ad's MSCLKID, and may allow for offline conversion imports. The present invention may apply to most digital ad channels and across most digital ad formats, such as Facebook Social Ads, Google Display Ads, YouTube Lead Forms, or Microsoft Search Ads. In some embodiments, if a visit is derived organically (i.e., not through digital advertising), the present invention may apply the same process via an IP address as opposed to unique click ID and source their visit via website analytics rather than an advertising platform.

In some embodiments the system may track organic efforts, such as, for example, links from directories or backlinks from other websites or blogs. The embodiments may, for example, source substantial value and may determine the source, and in turn, may potentially scale that source. For instance, if there were substantial revenues being generated from a blog in which a link was paid for, this would provide an opportunity to sponsor more content.

Additionally, in some embodiments, the system may match an IP address with organic lift during an offline advertising airing, such as, for example, a TV spot airing during a time of day where average visits are 0 and suddenly there are 100 direct visits. In such a situation it would be reasonable that such an anomaly may be generated by TV ads and the present invention may infer that the visit was generated by a TV ad, source the spot time and station, match to the creative that ran, and optimize offline advertising buys in that manner.

In some embodiments, TVs connected to internet, like Smart TVs, may be tracked via IP + and matched to channel and ad seen, and then corresponded with a later customer record. In some embodiments, for example, if a direct visit is generated from an IP address near a new billboard, and that area began to see a lift in conversion value, the system could infer based on the location data in Analytics that the value generated from the surrounding area that the billboard influenced a transaction, and we may decide to purchase more billboards.

In some embodiments, with enough data aggregated, the system may detect trends that would be otherwise unknown and be able to make more educated decisions about how to gear advertising or organic efforts toward revenue and profit, as opposed to only costs per lead.

In some embodiments, there is a program that may enable connectivity between multiple platforms that any customer may encounter along the way. In some embodiments the present invention may enable offline events to be tracked in the same way, bringing the same degree of visibility into service-based industries whose transactions occur in person. Furthermore, within each record, there may be a gross transaction value and may also include cost of goods, which, for example, may be based on a job performed. Further, this may also include the cost of advertising, which for example, may be based on the amount spent on source or percentage. Further, this may also include the cost of labor, which, for example, may be based on employees and hours. In some embodiments, the aggregate of these data points may result in a net profit per record, and report that number back into the ad platforms and analytics to optimize even beyond conversion value or revenue, but toward profitability. In some embodiments, this data may not only inform budget allocations between channels but also inform bids and creative decisions based on the insights unlocked by finding an ad source.

In some embodiments, integration may be provided between advertising applications, call tracking and website applications, CRM applications or databases, and analytics applications, to track offline revenue and profit for purposes of attribution on a user level.

In some embodiments, it may be that click generated IDs, such as Google Ad's GCLID, Facebook Ad's FBCLID and Microsoft Ad's MSCLKID, and IP Addresses from organic visits may be captured. In some embodiments, this may be the manner of associating a customer record with their point of origination or path. Either via hidden fields in a website form or capturing and matching of a web visit to a phone call, the present invention, in some embodiments may pass such information into a CRM custom field or our database. Once that customer's record is updated with their transaction, the present invention may, for example, extract that transaction value along with the click ID and pass it back into the ad platform as an offline conversion event, or, for example, it may pass the IP and value back into a website analytics platform and subsequently associate it with the source of the visits or any along the way. In some embodiments, integration may be provided between advertising applications, CRM applications, and analytics applications to track offline revenue and profit for purposes of attribution on a user level.

In some embodiments, the present invention may relate to a computer-based method for integrating tracking information into CRM or database based on user interaction with an online advertisement on various advertising platforms and then may use sales-related information from the CRM for that user to report back to the Advertising platform.

In some embodiments of the present invention the computer program may be written in the Python Programming Language, however, various other programming languages may also be used such as, for example, C, C++, Java, Go, Swift, Objective-C, JavaScript, and many others. In some embodiments, the integration may be implemented via an Asynchronous programming approach. Such an approach may use, for example, the asyncio (Asynchronous I/O) concurrency method and may run on one process and single thread on the Operating system, thereby increasing the performance and responsiveness of the program.

In some embodiments, this method may have two parts:

### Part I:

In some embodiments, the method may begin by integrating tracking details to Lead/User record in a Customer Relationship Management (“CRM”) system, or to the database if the CRM is not available: In some embodiments, the program may integrate the tracking system and the CRM using APIs provided by these platforms. In some embodiments, APIs may not be available, in that case the present invention could export the data into a data file, such as, for example, comma separated values (.csv) files and use them for the integration.

In some embodiments, the present invention may use the CALLRAIL API to get the tracking details like GCLIDs, FBCLIDs, etc. for every lead generated from an AD. The computer program may be notified from CALLRAIL if there is, for example, a new call/form lead along with click IDs of the advertising platform. The program may then use an API from CRM to search that lead by using, for example, a Phone Number or Email Address and assign the lead with a respective click ID.

### Part II:

In some embodiments, the second step may be to integrate the CRM with the advertising platforms: In some embodiments, when a sale is recorded for Lead, the program may check whether the lead has any click IDs associated with it in the CRM and if it finds click IDs, the program may then send the sales amount, date and time the sales were made and the click IDs to the Advertising platform, such as, for example, Google Ads, Facebook, etc.

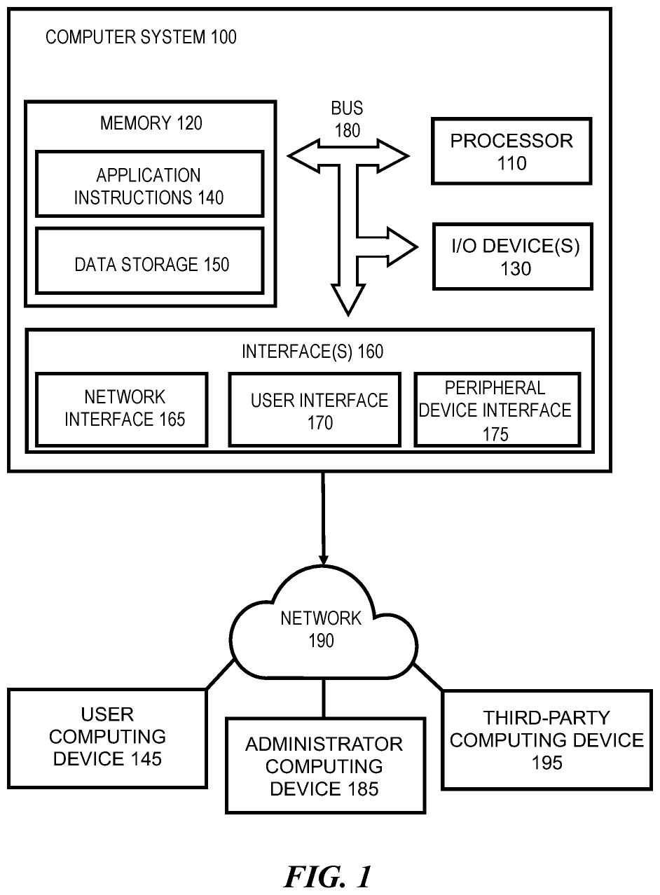

FIG. 1 illustrates an example of a computer system 100 that may be utilized to execute various procedures, including the processes described herein. The computer system 100 comprises a standalone computer or mobile computing device, a mainframe computer system, a workstation, a network computer, a desktop computer, a laptop, or the like. The computing device 100 can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

In some embodiments, the computer system 100 includes one or more processors 110 coupled to a memory 120 through a system bus 180 that couples various system components, such as an input/output (I/O) devices 130, to the processors 110. The bus 180 may be any of several types of bus structures including a memory bus or memory controller, a peripheral bus, and a local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

In some embodiments, the computer system 100 includes one or more input/output (I/O) devices 130, such as video device(s) (e.g., a camera), audio device(s), and display(s) are in operable communication with the computer system 100. In some embodiments, similar I/O devices 130 may be separate from the computer system 100 and may interact with one or more nodes of the computer system 100 through a wired or wireless connection, such as over a network interface.

Processors 110 suitable for the execution of computer readable program instructions include both general and special purpose microprocessors and any one or more processors of any digital computing device. For example, each processor 110 may be a single processing unit or a number of processing units and may include single or multiple computing units or multiple processing cores. The processor(s) 110 can be implemented as one or more microprocessors, microcomputers, microcontrollers, digital signal processors, central processing units, state machines, logic circuitries, and/or any devices that manipulate signals based on operational instructions. For example, the processor(s) 110 may be one or more hardware processors and/or logic circuits of any suitable type specifically programmed or configured to execute the algorithms and processes described herein. The processor(s) 110 can be configured to fetch and execute computer readable program instructions stored in the computer-readable media, which can program the processor(s) 110 to perform the functions described herein.

In this disclosure, the term “processor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum-dot based transistors, switches, and gates, to optimize space usage or enhance performance of user equipment. A processor can also be implemented as a combination of computing processing units.

In some embodiments, the memory 120 includes computer-readable application instructions 150, configured to implement certain embodiments described herein, and a database 150, comprising various data accessible by the application instructions 140. In some embodiments, the application instructions 140 include software elements corresponding to one or more of the various embodiments described herein. For example, application instructions 140 may be implemented in various embodiments using any desired programming language, scripting language, or combination of programming and/or scripting languages (e.g., C, C++, C #, JAVA, JAVASCRIPT, PERL, etc.).

In this disclosure, terms “store,” “storage,” “data store,” data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Generally, a computing device will also include, or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, the steps and actions of the application instructions 140 described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, the application instructions 140 for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The application instructions 140 can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

In some embodiments, the application instructions 140 can be downloaded to a computing/processing device from a computer readable storage medium, or to an external computer or external storage device via a network 190. A network adapter card or network interface in each computing/processing device receives computer readable program instructions from the network and forwards the computer readable application instructions 140 for storage in a computer readable storage medium within the respective computing/processing device.

In some embodiments, the computer system 100 includes one or more interfaces 160 that allow the computer system 100 to interact with other systems, devices, or computing environments. In some embodiments, the computer system 100 comprises a network interface 165 to communicate with a network 190. In some embodiments, the network interface 165 is configured to allow data to be exchanged between the computer system 100 and other devices attached to the network 190, such as other computer systems, or between nodes of the computer system 100. In various embodiments, the network interface 165 may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol. Other interfaces include the user interface 170 and the peripheral device interface 175.

In some embodiments, the network 190 corresponds to a local area network (LAN), wide area network (WAN), the Internet, a direct peer-to-peer network (e.g., device to device Wi-Fi, Bluetooth, etc.), and/or an indirect peer-to-peer network (e.g., devices communicating through a server, router, or other network device). The network 190 can comprise copper transmission cables, optical transmission fibers, wireless transmission, routers, firewalls, switches, gateway computers and/or edge servers. The network 190 can represent a single network or multiple networks. In some embodiments, the network 190 used by the various devices of the computer system 100 is selected based on the proximity of the devices to one another or some other factor. For example, when a first user device and second user device are near each other (e.g., within a threshold distance, within direct communication range, etc.), the first user device may exchange data using a direct peer-to-peer network. But when the first user device and the second user device are not near each other, the first user device and the second user device may exchange data using a peer-to-peer network (e.g., the Internet). The Internet refers to the specific collection of networks and routers communicating using an Internet Protocol (“IP”) including higher level protocols, such as Transmission Control Protocol/Internet Protocol (“TCP/IP”) or the Uniform Datagram Packet/Internet Protocol (“UDP/IP”).

Any connection between the components of the system may be associated with a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and nonvolatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer-readable storage media and/or a tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

In some embodiments, the system can also be implemented in cloud computing environments. In this context, “cloud computing” refers to a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

As used herein, the term “add-on” (or “plug-in”) refers to computing instructions configured to extend the functionality of a computer program, where the add-on is developed specifically for the computer program. The term “add-on data” refers to data included with, generated by, or organized by an add-on. Computer programs can include computing instructions, or an application programming interface (API) configured for communication between the computer program and an add-on. For example, a computer program can be configured to look in a specific directory for add-ons developed for the specific computer program. To add an add-on to a computer program, for example, a user can download the add-on from a website and install the add-on in an appropriate directory on the user's computer.

In some embodiments, the computer system 100 may include a user computing device 145, an administrator computing device 185 and a third-party computing device 195 each in communication via the network 190. The user computing device 145 may be utilized by any user associated with the application program and computing system. The administrator computing device 185 may include users having administrative functions, or by managers and/or executives of the enterprise. The third-party computing device 195 may be utilized by third parties to receive communications from the user computing device and/or administrative computing device 185, to transmit communications to the user via the network, and otherwise interact with the various functionalities of the system. In one example, the third-party computing device may be in communication with a CRM system.

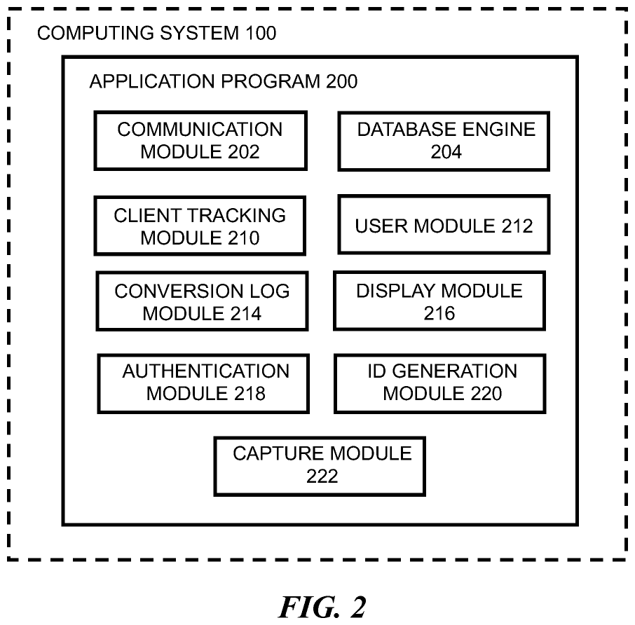

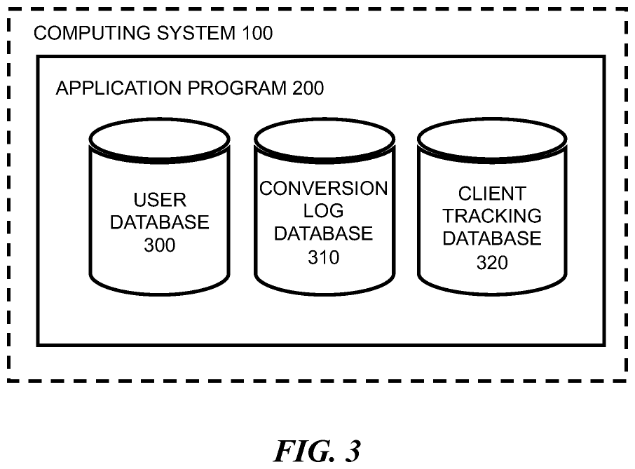

FIGS. 2 and 3 illustrate an example computer architecture for the application program 200 operated via the computing system 100. The computer system 100 comprises several modules and engines configured to execute the functionalities of the application program 200, and a database engine 204 configured to facilitate how data is stored and managed in one or more databases. In particular, FIG. 2 is a block diagram showing the modules and engines needed to perform specific tasks within the application program 200, and FIG. 3 is a block diagram showing the various databases utilized by the various modules.

Referring to FIG. 2, the computing system 100 operating the application program 200 comprises one or more modules having the necessary routines and data structures for performing specific tasks, and one or more engines configured to determine how the platform manages and manipulates data. In some embodiments, the application program 200 comprises one or more of a communication module 202, a database engine 204, a client tracking module 210, a user module 212, a conversion log module 214, a display module 216, an authentication module 218, an ID generation module 220, and a capture module 222.

In some embodiments, the communication module 202 is configured for receiving, processing, and transmitting a user command and/or one or more data streams. In such embodiments, the communication module 202 performs communication functions between various devices, including the user computing device 145, the administrator computing device 185, and a third-party computing device 195. In some embodiments, the communication module 202 is configured to allow one or more users of the system, including a third-party, to communicate with one another. In some embodiments, the communications module 202 is configured to maintain one or more communication sessions with one or more servers, the administrative computing device 185, and/or one or more third-party computing device(s) 195. In some embodiments, the communication module 202 allows each user to transmit and receive information which may be used by the system.

In some embodiments, a database engine 204 is configured to facilitate the storage, management, and retrieval of data to and from one or more storage mediums, such as the one or more internal databases described herein. In some embodiments, the database engine 204 is coupled to an external storage system. In some embodiments, the database engine 204 is configured to apply changes to one or more databases. In some embodiments, the database engine 204 comprises a search engine component for searching through thousands of data sources stored in different locations. The database engine 204 allows each user and module associated with the system to transmit and receive information stored in various databases.

In some embodiments, the client tracking module 210 is configured to track customer interactions with the system, including various steps throughout the conversion path (e.g., initial contact, negotiations, onboarding, execution of a deal, etc. The client tracking module 210 may interact with various user data stored in the user database 300 (see FIG. 3).

In some embodiments, the user module 212 facilitates the creation of a user account for the application system. The user module 212 may allow the user to create user preferences, establish user credentials, set user goals related to the enterprise, define the user's role within the enterprise, etc. The user module 212 may determine the role of the user based on their credentials, such as by defining which department or sector the user operates in within the enterprise (e.g., sales, marketing, management, etc.).

In some embodiments, the conversion log module 214 is configured to track conversion paths and associate that click sourcing with their record that exists in either a CRM or our conversion log database 310 (see FIG. 3). This may be reported back to the click originations for revenue and profit tracking in the advertising platforms by which they originated or contributed to the conversion path. The conversion log module 214 may account for both single clicks, and multi-channel.

In some embodiments, the display module 216 is configured to display one or more graphic user interfaces, including, e.g., one or more user interfaces, one or more consumer interfaces, one or more video presenter interfaces, etc. In some embodiments, the display module 216 is configured to temporarily generate and display various pieces of information in response to one or more commands or operations. The various pieces of information or data generated and displayed may be transiently generated and displayed, and the displayed content in the display module 216 may be refreshed and replaced with different content upon the receipt of different commands or operations in some embodiments. In such embodiments, the various pieces of information generated and displayed in a display module 216 may not be persistently stored.

In some embodiments, the authentication module 218 is configured to may authenticate users, interactions, third-parties, and the like.

In some embodiments, the ID generation module 220 is configured to generate a unique click IDs for an online advertisement.

In some embodiments, a capture module 222 is configured to capture an IP address and unique calls.

FIG. 3 illustrates the computing system 100 in operable communication with the application program 200 having a plurality of databases in communication thereto. A user database 300 stores user data including user interactions (e.g., clicks), call data, record data, and the like. A conversion log database 310 stores conversions logs to track conversion paths and associate that click sourcing with their record. A client tracking database 320 stores client interactions with the system, including various steps throughout the conversion path (e.g., initial contact, negotiations, onboarding, execution of a deal, etc.

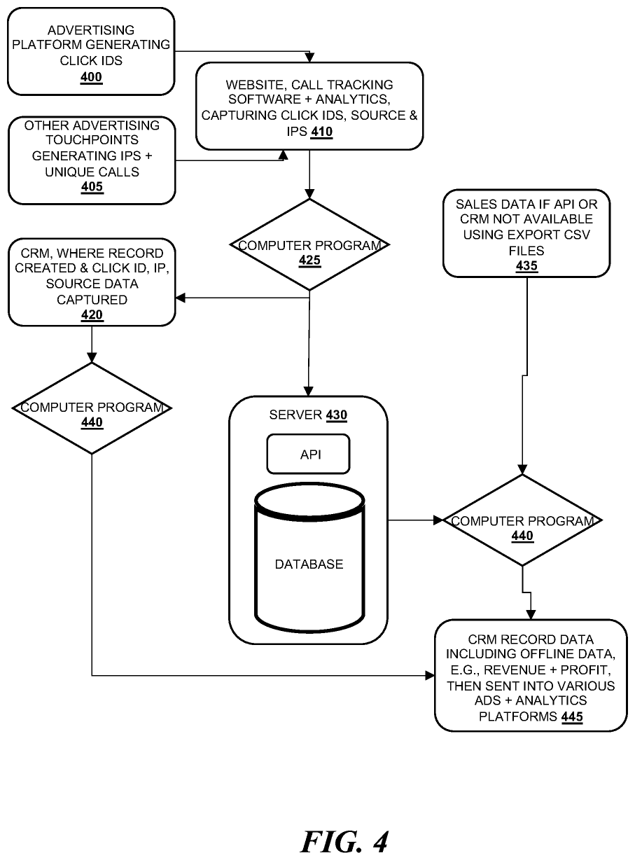

FIG. 4 illustrates a block diagram of the system flow including an advertising platform 400, a third-party advertising platform 405, and a third party tracking software 410. A process for capturing the click IDs from CALLRAIL and appending to lead record in the CRM is illustrated in block 415. The CRM 420 is provided wherein where all the Leads/Users are stored along with other related data. In block 425, a computer program which captures sales generated for a lead in the CRM and reports to the advertising platform like Google, Facebook where the Lead was generated is illustrated. In block 430, the server in case CRM is not available/or APIs are not available for the CRM. The server consists of combination of API Gateway, Lambda Function and DynamoDB provided and hosted on Amazon Web Services (AWS). Lead data like Name, Address, Email address, Phone Number along with click IDs are stored using the API. In block 435, a data file that contains sales data when a CRM or an API is not available. The data file can be located on a file hosting service accessible via an FTP or any other mode. In block 440, computer program which reads the data file for sales data and matches Lead records on our database and reports back to Advertising Platform. In block 445, Advertising Platform using APIs provided by Advertising platforms such as Google, Facebook to report the sales data back is illustrated.

In some embodiments, the system includes code that fetches lead tracking data from tracking software and stores on the server. In some embodiments, the goal may be to capture Lead Data from a Calls/Form Submissions and various other Advertising platform. Fields that may be captured, for example, may be Phone Number, Email Address, Source, Click ID, Click ID Type, IP Address, Date/Time (UTC) of click generated, Valid Status. In some embodiments, when a click is generated, it may be valid 2-3 months depending upon the advertising platform. In the case of Google, for example, a click may expire after 90 days.

In some embodiments, the present invention may use an API provided by tracking software like Call rail, in order to pull the tracking data. In some embodiments, the present invention may make use of Webhooks and/or an API. Webhooks are signals/requests send by server when a specific event occurs. They send the event data in the body of the request. In the case where webhooks may not be available in the tracking software, we may send timely requests using the API to fetch the tracking data. The data may be, for example, in JSON format and the present invention may use an inbuilt JSON library in Python to parse that JSON data.

In some embodiments, the present invention may then store these fields on a Server (see Block 430) by sending HTTP post requests to the server. In some embodiments, the present invention may use an API Gateway, Lambda Function and DynamoDB services provided by AMAZON WEB SERVICES (AWS) to store tracking data. Once the system sets up an API Gateway in AWS, the present invention may, for example, create an endpoint where the computer program (block 425) sends a POST request with the tracking lead data and pass it to AWS Lambda.

In AWS Lambda, the system may, in some embodiments create a lambda function using Python which will take the above request and parse to an extract Phone Number, Email Address, Source, Click ID, Click ID Type, IP Address, Date/Time, Valid Status and store them in DynamoDB. In some embodiments, DynamoDB may be used as the NoSQL key-value database.

Some of the benefits of using DynamoDB may be, for example, scalability and performance, inbuilt security, backup and in-memory caching. In such, the system may store Tracking Data on the server. In some embodiments, the system may store Click IDs ever generated to perform a mathematical calculation when attributing revenue to the Advertising platform. In some embodiments, “Valid Status” may be 1 when the click is added to the database and its status may automatically change to 0 if the Date/Time has passed the expiration time of that Click ID.

In some embodiments, the goal of the present invention may be to fetch the revenue generated with the CRM and report back to the Advertising platform. The system may deploy and run the code on the AWS EC2 Instance. EC2 (Elastic Compute Cloud) may allow the creation of instances of virtual machine on the cloud and capacity to scale instances.

In some embodiments, the present invention may fetch Phone Numbers, Email Addresses, Revenue/Profit/Sales information from the CRM. In some embodiments, the present invention may use a Webhook/API provided by the CRM to get this data. Below is an example of sample code of fetching Completed Jobs from a CRM using an API that may be utilized in some embodiments of the present invention. In some embodiments, we may use Async IO module built in python for asynchronous operations.

The use of Async programming may allow the present invention to make use of callback, events and event handlers. Below, for example, may be steps in some embodiments of the present invention how that enable to capability of fetching a list of completed jobs from a CRM.

In some embodiments, to make API requests, for example, the present invention may use Client Session instance of Aiohttp module. Client Session enables the present invention to keep the same objects for all requests. In order to close Session for requests made using Client Session the present invention may use “async with,” it may close the session after making all requests.

In some embodiments, the system may open the client session, the system may then use such a session to make requests to the API URL along with a completed job date range parameter. In some embodiments, the API may return a response object. The present invention may then convert the response object into JSON format to fetch Revenue, Phone Number, Email Address and store such information in a python list object.

If the list of completed jobs is large, the API may return such data in pagination. The present invention may make use of a “While loop” to loop through all pages to get the final data.

To start the program, we use event loop by creating an instance of asyncio loop and append the tasks to it. This will return the list of all completed jobs within the data range specified.

In order to fetch data from the CRM, if the API is not available or not provided by the CRM, in some embodiments, the present invention may export the data in a CSV format and parse the required information. The present invention may use Pandas, which is an open source data analysis library built in Python.

In some embodiments, the Fetched Phone Number and/or Email Address from the CRM may then be queried in the database on the AWS server. The query may only fetch Valid Click IDs. The query result may then, for example, be returned with Click ID, Click ID Type, or Date/Time.

In some embodiments, this offline conversion tracking program may account for both single clicks, and multi-channel. Meaning traditionally, if one figured a way to set up an offline conversion tracking method with a CRM, which partially has components of this process as native integrations, it would report 100% of the conversion's value to 1 single ad platform, or if it were really customized to report to multiple it would report 100% of the conversion value to each single ad platform, resulting in duplicated conversion value and inaccurate data. The model of the present invention is unique in that it actually runs through the program of cross channel attribution models such as (but not limited to) linear, time decay, first click, last click, position based or custom models that have been built to leverage artificial intelligence, to distribute fractional credit to multiple advertising platforms, depending on attribution model of preference.

Additionally, in some embodiments, since some platforms have unique rules, such as GCLIDs from Google Ads expire after 90 days, each of our interactions may be time stamped, and the logic may ignore that touchpoint in the present invention's attribution model if the Click ID were expired, thus distributing weighted value to the remaining touchpoints and yielding maximum accuracy and accountability.

To allocate Revenue to each Click ID found in the above step, in some embodiments, if the present invention utilized the custom model of the present invention in place of a standard model option, the present invention may favor use of Benford's Law for Revenue Attribution. Whereas top Importance may be given to number First Click, then to second click and so on. According to the Law, there may be a 30.1% probability of occurrence of number 1, 17.6% for number 2, 12.4% for number 3. Inspired by Benford's Law and depending on the number of clicks, the present invention may calculate the revenue that needs to be attributed to each click. So, for example, if there are 3 valid clicks found in the database for a given customer, the present invention may attribute 49.96% of the total revenue to the first click, 29.21% to the second click and 20.83% to the third or last click.

In some embodiments, a calculated single or multi-channel revenue may then be reported back to the Advertising platform using their respective offline conversion API.

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrase “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

What is claimed is:

1. A system for integrating advertising with third-party platforms, the system comprising:
at least one user computing device in operable connection with a network;
an application server in operable communication with the user network, the application server configured to host an application program for providing a system for integrating advertising with one or more third-party platforms, the application program having a user interface module for providing access to the application program through the user computing device;
an ID generation module to generate a unique click IDs for an online advertisement; and
a capture module to capture an IP address and unique calls.

2. The system of claim 1, wherein the record is associated with a CRM.

3. The system of claim 2, wherein the CRM stores a lead record.

4. The system of claim 1, wherein the record is associated with a conversion log database.

5. The system of claim 1, further comprising a client tracking module configured to track one or more customer interactions.

6. The system of claim 1, further comprising a conversion log module configured to track one or more conversion paths and associate a clock with the lead record.

7. The system of claim 1, wherein a third-party is in communication, via the communication module, with the application program.

8. The system of claim 7, wherein the third-party is an offline third-party.

9. The system of claim 1, further comprising a conversion log database to store one or more conversion logs to track a conversion path.

10. The method of claim 1, further comprising a client tracking database to store one or more client interactions and associate a clock with a record.

11. A method for integrating advertising with third-party platforms, the system comprising:
selecting, via a user, at least one conversion path via at least one selection on a user interface;
associating the at least one selection with a record; and
reporting the record to the selection origination to monitor revenue and profit of an advertising platform.

12. The method of claim 11, wherein the record is associated a CRM.

13. The method of claim 11, wherein the record is associated with a record database.

14. The method of claim 11, wherein the record is associated with a conversion log database.

15. The method of claim 11, further comprising a client tracking module configured to track one or more customer interactions.

16. The method of claim 11, further comprising a conversion log module configured to track one or more conversion paths and associate a clock with the lead record.

17. The method of claim 11, further comprising a conversion log database to store one or more conversion logs to track a conversion path.

18. The method of claim 11, further comprising a client tracking database to store one or more client interactions and associate a clock with a record.
